(19) United States
(12) Patent Application Publication
(10) Pub. No.: US 2026/0180276 A1
(43) Pub. Date: Jun. 25, 2026

(54) All-Fiber Inline Optical Taps Adopting A Configuration Of Side-Pump Signal-And-Pump Combiners

(71) Applicant: Lightel Technologies, Inc., Renton, WA (US)

(72) Inventors: Chungho Hsia, San Jose, CA (US); Pai-Sheng Shen, Bellevue, WA (US)

(21) Appl. No.: 19/001,331

(22) Filed: Dec. 24, 2024

(51) Int. Cl. H01S 3/067; H01S 3/00; H01S 3/094; H01S 3/0941; H01S 3/23

(52) U.S. Cl. CPC H01S 3/06745; H01S 3/0014; H01S 3/06733; H01S 3/094019; H01S 3/0941; H01S 3/2308

(57) ABSTRACT

An all-fiber inline optical tap adopts a configuration of a side-pump signal-and-pump combiner with a double-clad fiber (DCF) and one or more multimode fibers (MMFs). DCF comprises a first cladding and a coupling portion, whereas each of MMFs comprises a taper portion fused around the coupling portion. MMFs are configured to extract a part of combined optical energy and a part of an optical signal leaking in the first cladding of DCF with a sampled optical power proportional to a fiber laser power in a propagating direction. By pre-selecting a proper taper slope of the taper portion and an embedded depth the MMFs fused and embedded in the coupling portion, the all-fiber inline optical tap can be built with a customized ratio used in fiber laser power monitoring, diagnostics, and controls of a fiber laser system.

### TECHNICAL FIELD

The present disclosure relates to all-fiber inline optical taps adopting a configuration of side-pump signal-and-pump combiners in high-power fiber laser and amplifier applications and more particularly to lossless inline optical taps configured to monitor output power of a fiber laser or a fiber amplifier for diagnostics and controls of the fiber laser or the fiber amplifier with improved beam quality and reliability.

### BACKGROUND

High power fiber lasers have received a wide attention in the past ten years. Such

lasers with several kilowatts (kWs) or several tens of kWs have been used as commercially available products in industries. In comparison with solid-state lasers, fiber lasers have a unique feature of a superb beam quality at high power due to an all-fiber configuration. That is, all the optical components used in the fiber lasers are of an optical fiber type and are connected using fusion splices without air interfaces between any two of the optical components in connection. The optical components comprise multiple diode laser pumps with multiple optical fiber pigtails, a rare-earth-doped optical fiber with two fiber Bragg gratings, a delivery fiber spliced to the rare-earth-doped optical fiber for a fiber laser output, and a signal-and-pump combiner with multiple input multimode fibers to splice to the multiple optical fiber pigtails of the multiple diode laser pumps and with a length of double-clad fiber (DCF) to splice to the rare-earth-doped optical fiber for a pump input. The rare-earth-doped optical fiber, doped with a rare earth element such as erbium (Er) or ytterbium (Yb) as a gain medium, provides for a beneficial geometry and a large surface to volume ratio, thus allowing for extraordinary heat dispersion and reducing thermal lensing effect when compared to rod type solid state lasers. The rare-earth-doped optical fiber with the gain medium receives and absorbs optical energy from the multiple diode laser pumps through the signal-and-pump combiner and creates a coherent laser light via a resonator built by using the two fiber Bragg gratings at two ends of the rare-earth-doped optical fiber. Such multimode fiber lasers in the 2-to 6-kW regime are ideal for cutting and welding, and particularly in an area of materials processing and laser machining as a reliable replacement for bulky diode pumped solid-state lasers and CO₂ lasers. It has been shown that lengthening the rare-earth-doped optical fiber can inherently increase power of the fiber lasers without a limit if a large mode area of DCF is used. However, DCFs used in both the length of DCF of the signal-and-pump combiner and the rare-earth-doped optical fiber are surrounded by polymer coatings with a limited tolerance to heat. In other words, the maximum thermal load provided by the polymer coatings dictates the maximum output power that the fiber laser can attain.

Not similar to optical fibers used in optical communications, where the coatings outside the optical fibers simply play a role of mechanical protection, the polymer coatings used in DCFs, however, perform mechanical and optical functions. DCFs use dual acrylate coatings, with a first low refractive index polymer coating in contact with the glass, and with a durable second coating to protect the first relatively soft low refractive index coating. In other words, the second coating mechanically protects the low refractive index coating from mechanical chips, cuts, or scratches which may result in optical energy to leak out from the optical fiber, possibly creating localized hot spots or catastrophic burns at high pump powers. DCFs with the dual acrylate coating can pass the stringent reliability test specified by Telcodia GR-20 standard used in the telecom industry.

An N×1 tapered fiber bundle (TFB) is used to combine multiple (“N”) inputs from multimode fiber pigtails connecting to multiple pump diodes into a single output, so called an end-pump combiner. The “N” satisfies the brightness conservation theorem, and the maximum “N” is 6, 13, 17, 24, 53, 63, 136, etc., depending on various combinations of various diameter and numerical aperture (NA) of the input optical fibers (i.e., the multiple multimode fibers) and the output optical fiber. In practice, the N is chosen to be far smaller than the maximum numbers specified above to provide some margin. The N×1 TFB is typically fabricated in a process similar to fused fiber couplers by bundling in parallel N multimode optical fibers that have been stripped of their polymer coatings. The N multimode optical fibers are then fused and tapered by heating with a flame such as electric arc, oxyhydrogen flame, or a CO₂ laser beam. A fused and tapered section is then cleaved in the middle and spliced to a single output fiber. The use of N×1 TFB to combine multiple laser diode pumps into one fiber is essential for pumping the fiber lasers. For a 7×1 TFB, each of seven input optical fibers with 200-μm diameter and 0.22-NA receives, for example, 200 W from each diode laser pump. Seven such laser pumps are combined into a single 400-μm double-clad fiber with 0.46-NA. This configuration gives a pumping module composed of active and passive components, delivering 1.4 kWs power for a fiber laser, based on the commercially available 200-W laser diode pumps. For more examples, with a Yb-doped fiber of 400-μm and 0.46-NA, a common TFB coupling six 200-μm 0.22-NA pump delivery fibers each with a pump power of 500 W provides a total power greater than 3 kWs. Using a 19×1 TFB and greater than 100-W pump power delivered in each 105-μm input optical fiber, a total of about 2-kW pump power can be achieved.

TFB can also be used in optical fiber amplifiers to combine pump and signal light that is confined to the core of a double-clad fiber. In this case, the fiber in the center of the tapered fiber bundle is replaced by the double-clad fiber with the core carrying an amplifier seed. This is commonly referred to as an (N+1)×1 combiner, which is critical for the optical fiber amplifiers or fiber lasers. As an example, a (6+1)×1 combiner accommodating six pump fibers and the double-clad fiber as a signal fiber can be used for a 1 kW co-pumped optical fiber amplifier, based on six pump diodes each delivering, for example, 250 W of pump power for a total pump power of 1.5 kWs. No matter whether 7×1 or (6+1)×1, the signal-and-pump combiner needs to be thermally managed to maintain its reliability. Specifically, the residual pump power, amplified spontaneous emission (ASE) power, and unwanted signal power trapped in an outer cladding of the double-clad fiber in the fiber lasers or the optical fiber amplifiers need to be removed to avoid potential damages to components downstream. The residual pump power can be in hundreds of watts in kW fiber lasers and the ASE can be in the range of many watts, typically much higher in the optical fiber amplifiers. The unwanted energy launching into the outer cladding of the double-clad fiber creates localized hot spots or catastrophic burns at high pump powers. The most efficient way to remove the cladding light is to strip the low-index fluoroacrylic coating off a length of the fiber and re-coat it with a high-index coating so that high-NA cladding light can be stripped.

A conventional signal-and-pump combiner is based on an end-pump technology and is basically an (N+1)×1 TFB pump combiner. The (N+1)×1 TFB pump combiner is a hexagonally packed fiber bundle fused and tapered for stability and high packing density. The resulting cross section of the hexagonally stacked bundle is close to a circle, and thus eases splicing with the output optical fiber. However, in making TFB, the signal fiber in a central position is tapered, twisted, and fused with “N” pump fibers. The signal fiber is significantly affected, resulting in an optical loss and beam quality degradation for a signal light. A splicing loss may be high due to a mode-field-diameter mismatch between the TFB and a rare-earth-doped double-clad fiber in applications of the optical fiber lasers and the optical fiber amplifiers.

With the emergence and development of double-clad fibers, large mode area fibers, semiconductor lasers as pumping sources, and cascade-pumping technologies, an output power of the fiber lasers continues to increase. The pumping sources and the resonant cavity with a gain medium are used through fiber fusion-splice processes. The all-fiber structure makes the system more compact and stable with a higher coupling efficiency and better reliability. A high coupling efficiency of an optical fiber signal-and-pump combiner is essential to build the fiber lasers with a high power level because a power carrying capability of such fiber lasers directly relates to the high coupling efficiency, which further determines an output power level of such fiber lasers. Such an optical fiber signal-and-pump combiner adopts a side-pump technology and uses a circumferential side of the double-clad fibers for one or more pump lights with a pump power to launch and couple into an inner cladding of the double-clad fibers without occupying two ends of the double-clad fibers, therefore, not affecting an input and an output of the signal light and its transmission. The main advantage of this technology is that the signal fiber in a central position is not tapered, which can greatly reduce the loss of the signal light, improve the coupling efficiency ensuring good performance, and maintain beam quality to potentially achieve a scheme, arrangement or configuration of multi-point cascade-pumping. Also, not like TFB based on the end-pump technology, the optical fiber signal-and-pump combiner based on the side-pump technology does not need cleaving in the middle of the TFB and splicing to another single output fiber. Furthermore, the double-clad fibers used in the optical fiber signal-and-pump combiner match most of rare-earth-doped double-clad fibers in NA and core and cladding diameters without a mode-field-diameter mismatch. Such features cannot be achieved using the end-pump technology of TFB mentioned above.

A side-pump based optical fiber signal-and-pump combiner with high reliability and good stability is of great significance for constructing fiber laser systems with a high power and a high beam quality because it can support “N” laser pumps launching into the (N+1)×1 optical fiber signal-and-pump combiner with all the signal and the pump power outputted from the one signal fiber to achieve a high output power. In reported all-fiber structures, the side-pump based signal-and-pump combiner is made by a fiber tapering and fusion method in which the tapered pumping fiber is directly fused with the inner cladding of the signal fiber, so called a side coupler, achieving higher pumping coupling efficiency and a power carrying capability of kilowatts of pumping power. Therefore, this technology has become a mainstream for making a high-power side-pump based optical fiber signal-and-pump combiner (side-pump signal-and-pump combiner, hereinafter). However, the conventional side-pump technology adopted to build such high-power side-pump signal-and-pump combiners needs the multi-point cascaded-pumping configuration, which introduces an accumulated splice loss and thus does not meet requirements. A reason of using the multi-point cascaded-pumping configuration is that parallel pumping using multiple channels of the signal-and-pump combiner is not commercially available due to production difficulties. Either coupling efficiency is not as high as expected or the overall insertion loss is not low enough, resulting in a low production yield.

A method of manufacturing the side-pump signal-and-pump combiner can be modified to build an all-fiber inline optical tap in high power fiber laser and amplifier applications, taking advantage of fiber compatibility among the double-clad fibers used in the side-pump signal-and-pump combiner, the fiber laser system, and the all-fiber inline optical tap. Such an all-fiber inline optical tap can be used to monitor output power of a fiber laser or a fiber amplifier for diagnostics and controls of the fiber laser or the fiber amplifier with improved laser output beam quality and reliability. It is, therefore, the purpose of this patent application to disclose structures and features of the all-fiber inline optical taps. Most importantly, the all-fiber inline optical tap is adaptable with all-fiber laser oscillators comprising at least one side-pump signal-and-pump combiner in a forward-pump, a backward-pump, or a bidirectional-pump configuration.

### SUMMARY

An all-fiber inline optical tap comprises a length of double-clad fiber and one or more multimode fibers as tapping fibers. Each of the tapping fibers comprises a taper portion with a predetermined taper slope and is configured to extract a part of an optical signal in the length of double-clad fiber. A sampled optical power extracted from the all-fiber inline optical tap is proportional to a fiber laser power in a propagating direction and easy to provide a quantitative control of the fiber laser or the fiber amplifier, rather than to offer only a system failure information and to issue an alarm. By pre-selecting a proper taper slope of the taper portion and an embedded depth the multimode fibers fused and embedded in the coupling portion, a ratio between the sampled optical power and the fiber laser power can be determined.

A fiber laser or a fiber amplifier, after a long period of usage, always shows a compromised laser output power due to aging of laser diodes, a laser cavity, and fiber components, affecting an output beam quality. Therefore, it is essential to provide a real-time monitoring of a fiber laser power at different monitoring locations such as a fiber laser output or an intra-cavity to feedback control and to optimally adjust the fiber laser output power, enhancing quality performance in material processing.

An all-fiber laser oscillator comprises a laser cavity comprising a high-reflector fiber-Bragg grating (HR FBG) and a low-reflectivity output coupler FBG (OC FBG). The intra-cavity refers to a location between the HR FBG and OC FBG. The all-fiber laser oscillator further comprises an amplification optical fiber comprising a section of double-clad fiber doped with a gain medium. The section of double-clad fiber is configured to couple between the HR FBG and the OC FBG and to produce a fiber laser light via the laser cavity. The all-fiber laser oscillator further comprises a plurality of diode lasers each comprising a laser source and a section of pump feeding fiber and configured to provide a portion of a combined optical energy for pumping the amplification optical fiber. The all-fiber laser oscillator further comprises at least one side-pump signal-and-pump combiner coupled with either or both of the HR FBG and the OC FBG. A forward-pump, a backward-pump, or a bidirectional-pump scheme may be adopted to provide a high pump power and to avoid excess heat at the at least one side-pump signal-and-pump combiner. The all-fiber laser oscillator further comprises an endcap configured to output the fiber laser light via a delivery fiber to a workpiece at a focal point. The all-fiber laser oscillator may further comprise a cladding power stripper (CPS) configured to remove any unabsorbed pump residual trapped in a cladding of the delivery fiber and to maintain beam quality of the fiber laser light.

The length of double-clad fiber in the all-fiber inline optical tap comprises a first core, a first cladding, and a second cladding over the first cladding and is configured to transport an optical signal in the first core with the optical signal bound in a first interface between the first core and the first cladding. The length of double-clad fiber further comprises a cladding-stripped portion comprising a coupling portion. A combined optical energy propagates in the length of double-clad fiber and is bounded in a second interface between the first cladding and the air around the cladding-stripped portion. Each of the one or more multimode fibers respectively comprises a second core, a third cladding, and outer claddings and buffer coatings over the third cladding. Each of the one or more multimode fibers further comprises a stripped portion with the outer claddings and buffer coatings stripped. A part of the stripped portion is configured to be pre-heated and stretched into a taper portion with a predetermined taper slope with respect to an optical axis of each of the one or more multimode fibers. A plurality of the taper portions formed in the one or more multimode fibers are configured to be further fused around the coupling portion with the third cladding directly coupled with the first cladding. Each of the one or more multimode fibers is configured to respectively extract a part of the combined optical energy or the optical signal leaking in the first cladding as an optical tap in the all-fiber inline optical taps.

As mentioned, the part of the optical signal extracted is a signal light leaking from the first core to the first cladding due to fiber bending or mismatch in propagation pathway whereas the part of the combined optical energy extracted is an unabsorbed pump residual. Either the part of the combined optical energy or the optical signal is configured to pass through the taper portion with a decreasing divergence angle against an optical axis of the taper portion for each internal reflection in the taper portion, thereby being extracted from the length of double-clad fiber with a reduced optical loss. Furthermore, the optical signal, after propagating through the coupling portion, continues to traverse in the first core and is bound in a first interface between the first core and the first cladding, thereby passing through the length of double-clad fiber with a reduced signal loss and a minimum beam quality degradation.

The length of double-clad fiber comprises an input and an output. A forward propagating direction is regarded as a direction from the input of a fiber laser source to the output whereas a backward propagating direction is regarded as a direction from the output to the input. Each of the one or more multimode fibers respectively comprises a downstream tap half close to the output of the length of double-clad fiber and an upstream tap half on an opposite side of the coupling portion, close to the input of the length of double-clad fiber. The one or more multimode fibers, thus, comprise a plurality of the downstream tap halves and a plurality of the upstream tap halves, whereas the plurality of the downstream tap halves and the plurality of the upstream tap halves are respectively configured to extract the part of either or both of the combined optical energy and the optical signal respectively in the forward propagating direction and in the backward propagating direction, taking advantage of high directivity of an external laser beam launched into the length of double-clad fiber and a back-reflection from an external workpiece during material processing.

The part of the combined optical energy and the part of the optical signal in the forward propagating direction are extracted via the downstream tap half and comprise both the leaking signal light of the optical signal and a pump residual energy from an external fiber laser source. A reflected part of the combined optical energy and the optical signal in the backward propagating direction are extracted via the upstream tap half and comprise a reflected part of the optical signal trapped in the first cladding without re-launching into the first core, a back-reflection leaking signal light escaped out from the first core to the first cladding due to fiber bending or mismatch, and a reflected stimulated Raman scattering (SRS) energy reflected from an external workpiece machined by the external fiber laser source.

The length of double-clad fiber is further configured to couple to an external CPS in the external fiber laser source and to remove a cladding light trapped in the first cladding, thereby improving optical signal quality. The all-fiber inline optical tap may further comprise a power amplifier section coupled between the external CPS and an output endcap. The power amplifier section comprises a section of double-clad fiber doped with the gain medium and a side-pump signal-and-pump combiner coupled in series with the section of double-clad fiber doped with the gain medium. The side-pump signal-and-pump combiner is configured to provide either or both of a forward-pump and a backward-pump in a master-oscillator power-amplifier configuration. The power amplifier section is configured to amplify a fiber laser light generated upstream. A part of either a backward-propagating laser light reflected from the workpiece or a forward-propagating laser light is extracted from each of the one or more multimode fibers for diagnostics and controls of a power gain in the power amplifier section.

The all-fiber inline optical tap may further comprise a CPS built on a fiber pigtail of the length of double-clad fiber as an integrated assembly to save additional splice, thereby further reducing an optical loss and preserving laser beam quality. Either the downstream tap half or the upstream tap half is configured to couple to an external optical filter to filter out an unwanted wavelength, thereby facilitating to extract either the part of the optical signal or the part of the combined optical energy for diagnostics and controls of the external fiber laser source. The integrated assembly with a built-in CPS in either the downstream tap half or the upstream tap half may also be configured to output an extracted light into an external optical filter to extract either the part of the optical signal or the part of the combined optical energy for diagnostics and controls of the external fiber laser source.

The length of double-clad fiber may be configured to couple with an external low-reflectivity output coupler fiber-Bragg grating (OC FBG) in an external laser cavity. Either the downstream tap half or the upstream tap half is used as an intra-cavity tap monitor and configured to extract a part of the optical signal in either or both of the forward propagating direction or the backward propagating direction for intra-cavity diagnostics and controls of the external fiber laser source. Either the downstream tap half or the upstream tap half may further be configured to couple to an external optical filter to extract either the part of the optical signal or the part of the combined optical energy for further diagnostics and controls of the external fiber laser source. The part of the optical signal in either or both of the forward propagating direction and the backward propagating direction is configured to couple to either or both of a photo detector and an optical spectrum analyzer for signal processing and controls of the external fiber laser source.

The plurality of pairs of the one or more multimode fibers have a sufficient light acceptance aperture such that either the combined optical energy or the optical signal extracted has a sampled power large enough to be used with a P-type semiconductor-Insulator-N-type semiconductor (PIN) diode, rather than an avalanche diode (APD), taking advantage of a low noise with a low dark current, a very low bias voltage needed, and a very high reverse bias voltage, thereby no need to operate APD at a high voltage, thus simplifying signal processing in applications.

The plurality of the taper portions may be configured to be further heated and stretched around the coupling portion. Each of the plurality of the taper portions is accordingly fused and embedded to an embedded depth in the coupling portion. The embedded depth and the predetermined taper slope can be used to control a ratio between a sampled signal power and a laser output power.

The all-fiber inline optical tap may further comprise an all-fiber laser oscillator, in which at least one side-pump signal-and-pump combiner is coupled with a high-reflector fiber-Bragg grating (HR FBG) and configured to provide a forward-pump in a co-pump configuration.

The all-fiber inline optical tap may further comprise an all-fiber laser oscillator, in which at least one side-pump signal-and-pump combiner is coupled with a low-reflectivity output coupler FBG (OC FBG) and configured to provide a backward-pump in a counter-pump configuration.

The all-fiber inline optical tap may further comprise an all-fiber laser oscillator, in which a first side-pump signal-and-pump combiner and a second side-pump signal-and-pump combiner are respectively coupled with a high-reflector fiber-Bragg grating (HR FBG) and a low-reflectivity output coupler FBG (OC FBG). The first and the second side-pump signal-and-pump combiners are respectively configured to provide a forward-pump and a backward-pump in a bidirectional-pump configuration.

The all-fiber inline optical tap to be used in high-power laser applications is different from a fiber tap coupler widely used in optical communications or telecommunications, so are their structures. However, a manufacturing method of building a side-pump signal-and-pump combiner in high-power fiber laser applications can be adopted in making the all-fiber inline optical tap. The manufacturing method may comprise multiple processes comprising a torch scanning process configured to control the fiber pulling tensions at the heated positions in the coupling portion, to regulate the rotation angle increment, and to embody an interlaced structure. The plurality of taper portions interlaced are further heated, stretched, and finally fused and embedded in the coupling portion, thereby controlling an extraction ratio between the extracted signal power and fiber laser output power. Note that the plurality of the taper portions are fused and embedded in the coupling portion without removing the downstream tap half and the upstream tap half of each of the plurality of the taper portions, thus forming a pair of the downstream tap half and the upstream tap half. Experimental results show that a (6+1)×1 all-fiber inline optical tap based on the structures of the side-pump signal-and-pump combiner according to the present disclosure can achieve a linearity of the extraction ratio of 98%, a stability of a sampled signal ratio better than 0.02 dB in one-hour period, and a beam quality (M² factor) of 1.3 for the fiber laser light with a high production yield while maintaining an insertion loss of 0.1 dB. Also, due to a wide dynamic range of the extraction ratio manageable during a manufacturing process, the all-fiber inline optical tap is feasible in various high-power fiber laser applications.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified. Moreover, in the section of detailed description of the invention, any of a “first”, a “second”, and so forth does not necessarily represent a part that is mentioned in an ordinal manner, but a particular one.

FIG. 1 is a perspective view of an all-fiber inline optical tap according to the present disclosure.

FIG. 2 is a front view of an all-fiber inline optical tap according to the present disclosure.

FIG. 3 is a back view of an all-fiber inline optical tap according to the present disclosure.

FIG. 4 is an extraction mechanism of an all-fiber inline optical tap according to the present disclosure.

FIG. 5 is a first configuration of an all-fiber inline optical tap used with an all-fiber laser oscillator according to the present disclosure.

FIG. 6 is a second configuration of an all-fiber inline optical tap used with an all-fiber laser oscillator according to the present disclosure.

FIG. 7 is a third configuration of an all-fiber inline optical tap used with an all-fiber laser oscillator according to the present disclosure.

FIG. 8 is a fourth configuration of an all-fiber inline optical tap used with an all-fiber laser oscillator according to the present disclosure.

FIG. 9 is a fifth configuration of an all-fiber inline optical tap used with an all-fiber laser oscillator according to the present disclosure.

### DETAILED DESCRIPTION OF VARIOUS EMBODIMENTS

Reference will now be made in detail to the preferred embodiments of the disclosure. Wherever possible, same or similar reference numerals are used in the drawings and the description to refer to the same or like parts or steps. The drawings are in their simplest form and are not to scale.

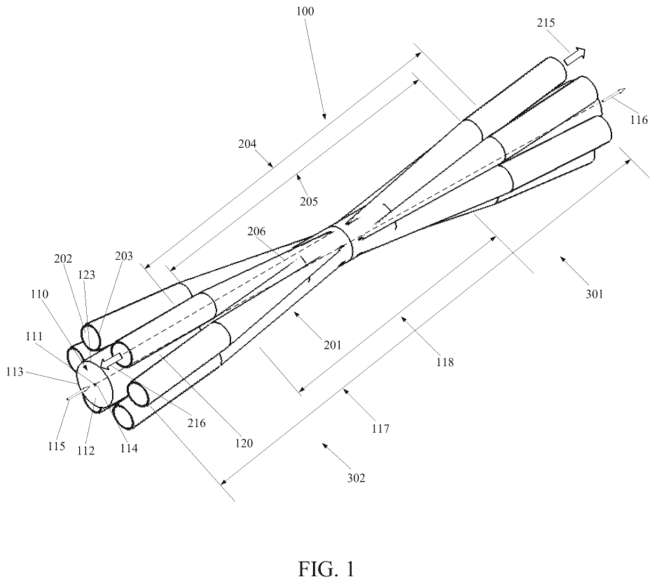

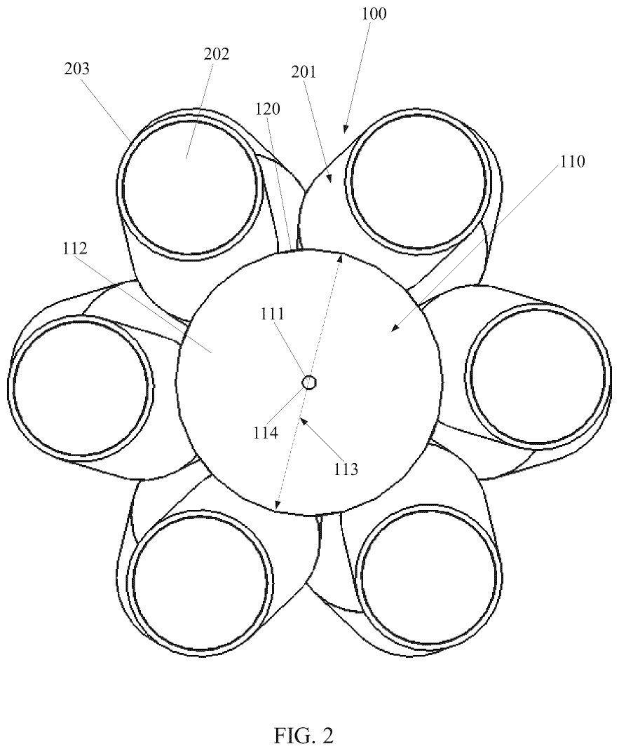

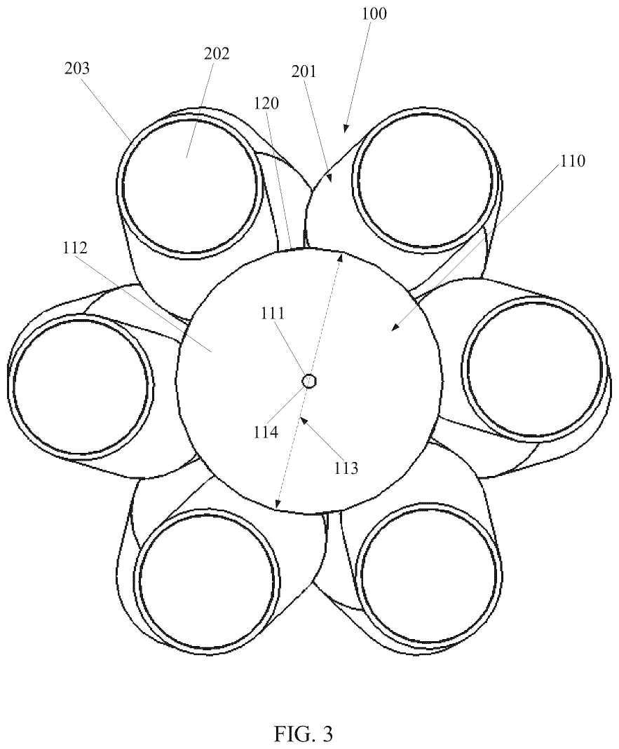

FIG. 1 is a perspective view of an all-fiber inline optical tap according to the present disclosure. FIG. 2 is a front view of an all-fiber inline optical tap according to the present disclosure. FIG. 3 is a back view of an all-fiber inline optical tap according to the present disclosure. Referring to FIGS. 1˜3, the all-fiber inline optical tap 100 comprises a length of double-clad fiber 110 and one or more multimode fibers 201 comprising six multimode fibers. So, the all-fiber inline optical tap is demonstrated using a configuration of a (6+1)×1 side-pump signal-and-pump combiner. The length of double-clad fiber 110 comprises a first core 111, a first cladding 112 with a diameter 113, a second cladding 123, and an outer polymer coating (not shown) over the second cladding 123, and is configured to transport an optical signal in the first core 111 with the optical signal bounded in a first interface 114 between the first core 111 and the first cladding 112. The optical signal propagates in a forward direction from an input 115 to an output 116 of the length of double-clad fiber 110. The length of double-clad fiber 110 further comprises a cladding-stripped portion 117 with both the second cladding 123 and the outer polymer coating stripped. The cladding-stripped portion 117 comprises a coupling portion 118 near middle of the length of double-clad fiber 110.

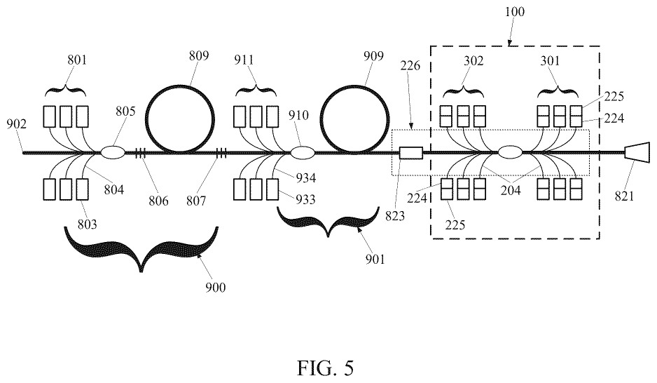

Referring to FIGS. 1˜3, each of the one or more multimode fibers 201 comprises a second core 202, a third cladding 203, outer claddings and buffer coatings (not shown) over the third cladding 203, and a section of multimode fibers 204 with the outer claddings and buffer coatings stripped. The section of multimode fibers 204 is configured to be pre-heated and stretched into a multimode fiber taper in a taper portion 205 with a predetermined taper slope with respect to an optical axis 206, for example, of each of the one or more multimode fibers 201. The multimode fiber taper in the taper portion 205 is configured to be fused around the coupling portion 118. The one or more multimode fibers 201 are configured to extract either a part of unabsorbed pump residual in the combined optical energy or a leaking optical signal escaped from the first interface 114 between the first core 111 and the first cladding 112. After propagating through the coupling portion 118, the optical signal continues to be guided in the first interface 114 between the first core 111 and the first cladding 112, whereas the unabsorbed pump residual in the combined optical energy continues to be guided in the first cladding 112 with the unabsorbed pump residual bounded in a second interface 120 between the first cladding 112 and the air 121 in the coupling portion 118. The predetermined taper slope has a positive sign in a forward propagating direction dictated from the input 115 to the output 116 of the length of double-clad fiber 110, meaning that the taper portion 205 has cross sections with their diameters progressively increased in the forward direction. Conversely, the backward propagating direction is dictated as a direction from the output 116 to the input 115. Note that a plurality of the taper portion 205 formed in the one or more multimode fibers 201 are configured to be fused around the coupling portion 118 with the third cladding 203 directly coupled with the first cladding 112 so that a sampled pump residual or a sampled optical signal can be guided to an extraction output due to a refractive index of the third cladding 203 less than that of the first cladding 112. Such a configuration ensures that either the combined optical energy (including the sampled pump residual) or the sampled optical signal extracted has a stable power large enough to be used with a P-type semiconductor-Insulator-N-type semiconductor (PIN) diode 225 (see FIGS. 5˜9), rather than an avalanche diode (APD), taking advantage of PIN diode 225 with a low noise with a low dark current, a very low bias voltage needed, and a very high reverse bias voltage, thereby no need to operate APD at a high voltage, thus simplifying signal processing in applications. Furthermore, the one or more multimode fibers 201 have a sufficient light acceptance aperture to receive an enough power to operate with the PIN diode 225.

Referring to FIGS. 1˜3, each of the one or more multimode fibers 201 respectively comprises a downstream tap half 301 close to the output 116 of the length of double-clad fiber 110 and an upstream tap half 302 on an opposite side of the coupling portion 118, close to the input 115 of the length of double-clad fiber 110. Thus, the one or more multimode fibers 201 comprise a plurality of the downstream tap halves and a plurality of the upstream tap halves, whereas the plurality of the downstream tap halves and the plurality of the upstream tap halves are respectively configured to extract the part of either or both of the combined optical energy and the optical signal respectively in the forward propagating direction and in the backward propagating direction, taking advantage of high directivity of an external laser beam launched into the length of double-clad fiber 110 and a back-reflection from an external workpiece during material processing. In other words, the downstream tap half 301 and the upstream tap half 302 are respectively configured to extract either the part of unabsorbed pump residual in the combined optical energy or the optical signal leaking from the first interface between the first core 111 and the first cladding 112 in either or both of the forward propagating direction and the backward propagating direction, taking advantage of high directivity of an external fiber laser beam launched into the length of double-clad fiber 110 and a back-reflection from an external workpiece (not shown) close to an endcap 821 (see FIGS. 5-9) during material processing. In other words, the downstream tap half 301 and the upstream tap half 302 are respectively used for signal extraction from a first exit 215 (see FIG. 1) and a second exit 216 respectively in the forward propagating direction and in the backward propagating direction. The downstream tap half 301 and the upstream tap half 302 can be built at the same time during a manufacturing process of being heated, stretched, and fused in the coupling portion 118, keeping a whole length of each of the one or more taper portions 205 without breaking and removing any part of the one or more taper portions 205. Thus, both the downstream tap half 301 and the upstream tap half 302 are built without additional manufacturing process. Referring to FIGS. 2˜3, the front view is same as the back view because the downstream tap half 301 and the upstream tap half 302 are built at the same time with a same taper structure and manufacturing processes including heating temperatures and a fusion time.

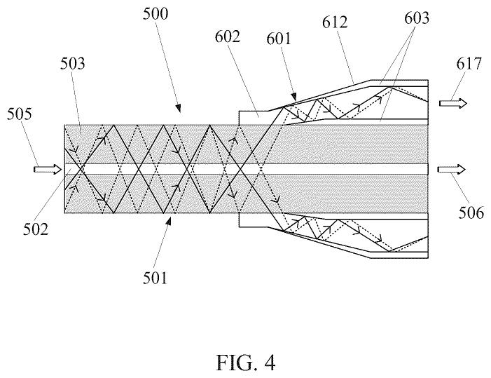

FIG. 4 is an extraction mechanism of an all-fiber inline optical tap according to the present disclosure. In FIG. 4, a (2+1)×1 all-fiber inline optical tap 500 is used as an example. The (2+1)×1 all-fiber inline optical tap 500 comprises a signal fiber 501 and two tapered fibers 601 fused symmetrically around the signal fiber 501. For simplicity, only one of the two tapered fibers 601, say, an upper tapered fiber 601 (i.e. the tapered fiber 601, hereinafter) will be depicted here. The signal fiber 501 is a double-clad fiber and comprises a core 502 and a first cladding 503 with a second cladding stripped (not shown). The signal fiber 501 is configured to transport an optical signal in the core 502. The optical signal is bounded in an interface between the core 502 and the first cladding 503. The optical signal propagates in a forward direction from an input 505 to an output 506 of the signal fiber 501. The tapered fiber 601 is a multimode fiber and comprises a taper portion 612. The tapered fiber 601 further comprises a core 602 and a cladding 603 and is separated from the first core 502 of the signal fiber 501 by the first cladding 503. The optical signal traverses in the first core 502 and is effectively bound in the interface between the first core 502 and the first cladding 503 without a significant degradation, as mentioned. The taper portion 612 has a predetermined taper slope with respect to an optical axis of the tapered fiber 601. The predetermined taper slope has a positive sign in a forward propagating direction from the input 505 to the output 506, meaning that the taper portion 612 has cross sections with their diameters progressively increased in the forward direction. The part of either the combined optical energy or the optical signal is configured to pass through the taper portion 612 with a decreasing divergence angle against an optical axis of the taper portion 612 for each internal reflection in the taper portion 612, thereby being extracted from the signal fiber 501 with a reduced optical loss. Furthermore, the optical signal, after propagating through the coupling portion, continues to traverse in the first core 502 and is bounded in the interface between the first core 502 and the first cladding 503, thereby passing through the signal fiber 501 with a reduced signal loss and a minimum beam quality degradation. To achieve a high extraction efficiency of the extracted light from the tapered fiber 501, a taper such as in the taper portion 612 is needed. When the extracted light passes through the taper, a beam divergence becomes smaller and smaller until the extracted light completes to be tapped out at an output 617.

FIG. 5 is a first configuration of an all-fiber inline optical tap used with an all-fiber laser oscillator according to the present disclosure. In FIG. 5, the all-fiber inline optical tap 100 is configured to couple against an output endcap 821. The all-fiber inline optical tap 100 further comprises a power amplifier section 901 coupled between an external CPS 823 and the all-fiber inline optical tap 100. The power amplifier section 901 comprises a section of double-clad fiber doped with a gain medium 909 and a side-pump signal-and-pump combiner 910 coupled in series with the section of double-clad fiber doped with the gain medium 909, such as Yb, Er, etc. In FIG. 5, the side-pump signal-and-pump combiner 910 further comprises a plurality of diode lasers 911 each comprising a laser source 933 and a section of pump feeding fiber 934 and is configured to provide a forward-pump in a master-oscillator power-amplifier (MOPA) configuration. Please note that the side-pump signal-and-pump combiner 910 may be configured to provide a backward-pump (not shown in FIG. 5 for clarity) in the MOPA configuration, depending on a different design. Another implementation may adopt both the forward-pump and the backward-pump mixed in the power amplifier section 901 to achieve a required performance. The power amplifier section 901 is configured to amplify a fiber laser light generated upstream. A part of a forward-propagating laser light is extracted from the downstream tap half 301 whereas a part of a backward-propagating laser light reflected from the workpiece (not shown) is extracted from the upstream tap half 302. Both extracted pump residual and optical signal, in both the forward-propagating direction and the backward-propagating direction may be used for diagnostics and controls of a power gain in the power amplifier section 901. In this case, the part of the optical signal in either or both of the forward propagating direction and the backward propagating direction are configured to couple to either or both of a photo detector and an optical spectrum analyzer to do the diagnostics and controls. In practice, the all-fiber inline optical tap 100 may further comprise a CPS 823 built on a fiber pigtail of the length of double-clad fiber 110 as an integrated assembly 226 to save additional splice and package, thereby reducing an optical loss and preserving laser beam quality. Either the downstream tap half 301 or the upstream tap half 302 is configured to output the extracted optical signal or unabsorbed pump residual to an external optical filter 224 to filter out an unwanted wavelength, thereby facilitating to extract either the part of the optical signal or the part of the combined optical energy for diagnostics and controls of the external fiber laser source. Similarly, the integrated assembly 226 with a built-in CPS in either the downstream tap half 301 or the upstream tap half 302 may be configured to output an extracted light into an external optical filter 224 to extract either the part of the optical signal or the part of the combined optical energy for diagnostics and controls of the external fiber laser source. The plurality of pairs of the one or more multimode fibers 201 have a sufficient light acceptance aperture such that either the combined optical energy or the optical signal extracted has a sampled power large enough to be used with a P-type semiconductor-Insulator-N-type semiconductor (PIN) diode, rather than an avalanche diode (APD), taking advantage of PIN diode with a low noise with a low dark current, a very low bias voltage needed, and a very high reverse bias voltage, thereby no need to operate APD at a high voltage thus simplifying signal processing in applications. As shown in FIG. 5, an external PIN diode 225 is used with the external optical filter 224.

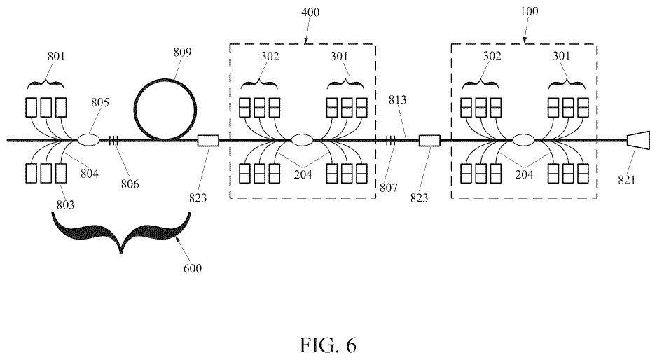

In FIG. 5, an all-fiber laser oscillator 900 comprises a laser cavity comprising a high-reflector fiber-Bragg grating (HR FBG) 806 and a low-reflectivity output coupler FBG (OC FBG) 807. The all-fiber laser oscillator 900 further comprises an amplification optical fiber comprising a section of double-clad fiber doped with a gain medium 809. The section of double-clad fiber doped with the gain medium 809 is configured to couple between the HR FBG 806 and the OC FBG 807 and to produce a fiber laser light via the laser cavity. The all-fiber laser oscillator 900 further comprises a plurality of diode lasers 801 each comprising a laser source 803 and a section of pump feeding fiber 804 and is configured to provide a portion of a combined optical energy for pumping the amplification optical fiber. The all-fiber laser oscillator further comprises at least one side-pump signal-and-pump combiner 805 coupled with either or both of the HR FBG 806 and the OC FBG 807. A forward-pump, a backward-pump, or a bidirectional-pump scheme may be adopted to provide a high pump power and to avoid excess heat at the at least one side-pump signal-and-pump combiner 805. The all-fiber laser oscillator 900 further comprises an endcap 821 configured to output the fiber laser light via a delivery fiber to a workpiece (not shown) at a focal point. The all-fiber laser oscillator 900 may further comprise the CPS 823 configured to remove any unabsorbed pump residual trapped in a cladding of the delivery fiber and to maintain beam quality of the fiber laser light. In FIGS. 6˜9, the all-fiber laser oscillator, the side-pump signal-and-pump combiner, and the integrated assembly mentioned will not be recited for simplicity.

FIG. 6 is a second configuration of an all-fiber inline optical tap used with an all-fiber laser oscillator according to the present disclosure. In FIG. 6, a first all-fiber inline optical tap 100 and a second all-fiber inline optical tap 400 are configured to be used with the all-fiber laser oscillator 600. The first all-fiber inline optical tap 100 is configured to couple between the external CPS and an output endcap whereas the second all-fiber inline optical tap 400 is configured to couple with an external low-reflectivity output coupler fiber-Bragg grating (OC FBG) 807 in an external fiber laser cavity. Either the downstream tap half 301 or the upstream tap half 302 in the second all-fiber inline optical tap 400 is used as an intra-cavity tap monitor and configured to extract either the part of the optical signal or the part of the combined optical energy in either or both of the forward propagating direction and the backward propagating direction for intra-cavity diagnostics and controls of the external fiber laser source.

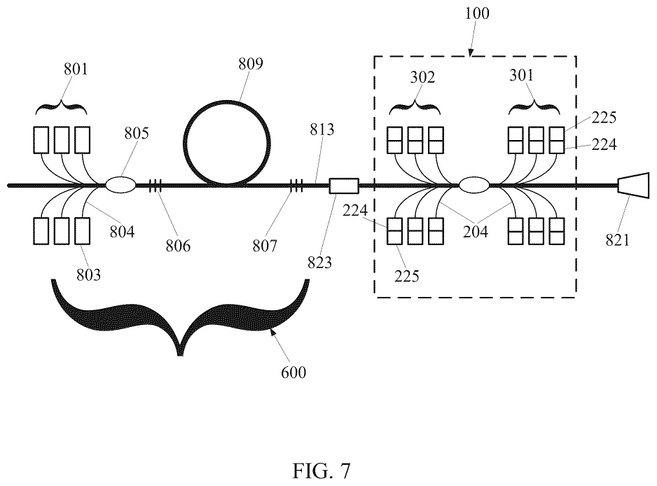

FIG. 7 is a third configuration of an all-fiber inline optical tap 100 used with an all-fiber laser oscillator according to the present disclosure. The all-fiber inline optical tap 100 may further comprise an all-fiber laser oscillator 600 configured to couple with the all-fiber inline optical tap 100 in an upstream direction, in which at least one side-pump signal-and-pump combiner 805 is coupled with a high-reflector fiber-Bragg grating (HR FBG) 806 and configured to provide a forward-pump in a co-pump configuration. The all-fiber inline optical tap 100 is configured to extract either the part of the optical signal or the part of the combined optical energy in either or both of the forward propagating direction and the backward propagating direction for diagnostics and controls of the external fiber laser source.

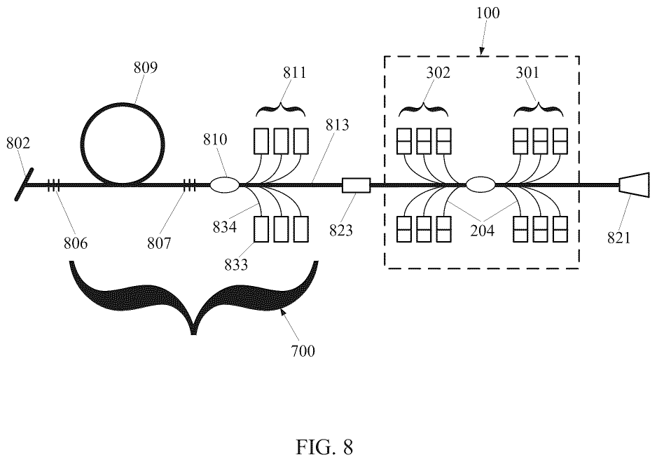

FIG. 8 is a fourth configuration of an all-fiber inline optical tap 100 used with an all-fiber laser oscillator according to the present disclosure. The all-fiber inline optical tap 100 may further comprise the all-fiber laser oscillator 700 configured to couple with the all-fiber inline optical tap 100 in an upstream direction, in which at least one side-pump signal-and-pump combiner 810 is coupled with a low-reflectivity output coupler FBG (OC FBG) 807 and configured to provide a backward-pump in a counter-pump configuration. The all-fiber inline optical tap 100 is configured to extract either the part of the optical signal or the part of the combined optical energy in either or both of the forward propagating direction and the backward propagating direction for diagnostics and controls of the external fiber laser.

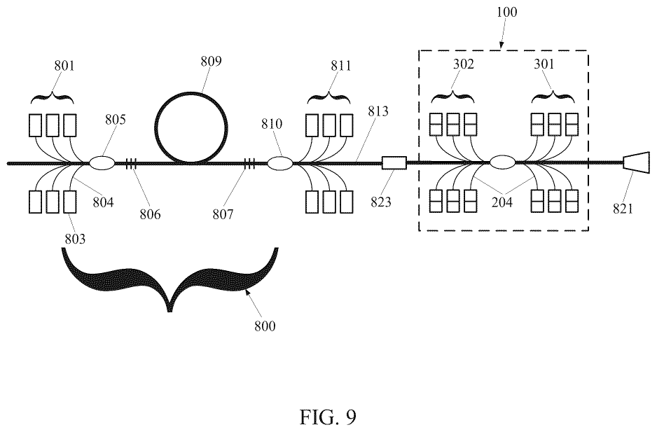

FIG. 9 is a fifth configuration of an all-fiber inline optical tap used with an all-fiber laser oscillator according to the present disclosure. The all-fiber inline optical tap 100 may further comprise the all-fiber laser oscillator 800, in which a first side-pump signal-and-pump combiner 805 and a second side-pump signal-and-pump combiner 810 are respectively coupled with a high-reflector fiber-Bragg grating (HR FBG) 806 and a low-reflectivity output coupler FBG (OC FBG) 807. The first and the second side-pump signal-and-pump combiners 805 and 810 are respectively configured to provide a forward-pump and a backward-pump in a bidirectional-pump configuration. The all-fiber inline optical tap 100 is configured to extract either the part of the optical signal or the part of the combined optical energy in either or both of the forward propagating direction and the backward propagating direction for diagnostics and controls of the external fiber laser.

In view of above, a method of producing the all-fiber inline optical tap 100 or 400 in FIG. 6 may comprise: (a) installing the one or more multimode fibers 201 stripped of outer claddings and buffer coatings in a jig; (b) pre-heating and stretching the one or more multimode fibers 201 stripped of outer claddings and buffer coatings to embody one or more multimode fibers taper portions 205 (one or more taper portions 205, hereinafter), each of the one or more taper portions 205 comprising a predetermined taper slope with respect to an optical axis 206 of each of the one or more multimode fibers 201; (c) inserting a length of double-clad fiber 110 stripped of an outer polymer coating in a central position of the jig without touching the one or more taper portions 205 ; and (d) heating and rotating the one or more taper portions 205 so that each of the one or more taper portions 205 is interlaced, fused, and embedded around a circumferential side of the length of double-clad fiber 110 stripped of the outer polymer coating. The method of producing the all-fiber inline optical tap 100 may comprise multiple processes further comprising a heat treatment process configured to heat and stretch the one or more taper portions 205 that are accordingly fused and embedded to an embedded depth in the coupling portion 118. The plurality of taper portions interlaced are further heated, stretched, and finally fused and embedded in the coupling portion to an embedded depth. The embedded depth and the predetermined taper slope can be customized to control an extraction ratio between the extracted signal power and laser output power. Note that the plurality of the one or more taper portions 205 are fused and embedded in the coupling portion, keeping a whole length of each of the one or more taper portions 205 without breaking and removing the downstream tap half 301 or the upstream tap half 302 of each of the plurality of the one or more taper portions 205, thus forming a pair of the downstream tap half 301 and the upstream tap half 302 for each of the one or more taper portions 205.

Although depicted in FIGS. 1˜3 and 5˜9 as six multimode fibers, the one or more multimode fibers 201 may comprise any integer number of downstream tap halves and upstream tap halves. For example, in a base design, the one or more multimode fibers 201 may comprise at least one downstream tap half with no upstream tap half. Depending on complexity of a fiber laser system in another example, the one or more multimode fibers 201 may comprise at least one downstream tap half and at least one upstream tap half. Unlike all the reported fiber tap coupler's structures, a configuration of a side-pump signal-and-pump combiner can be adopted in making the all-fiber inline optical taps with manufacturing methods and multiple processes similar to the side-pump signal-and-pump combiner. In experiments, six 105 μm-core/125 μm-cladding multimode fibers are used with the length of double-clad fiber of 25 μm-core/300 μm-cladding to build the all-fiber inline optical tap 100. In another experiment, the length of double-clad fiber of 20 μm-core/400 μm-cladding is used.

Whereas preferred embodiments of the present disclosure have been shown and described, it will be realized that alterations, modifications, and improvements may be made thereto without departing from the scope of the following claims. Another all-fiber inline optical taps adopting various configurations of a side-pump signal-and-pump combiner to accomplish the same or different objectives could be easily adapted for use from the present disclosure. Accordingly, the foregoing descriptions and attached drawings are by way of example only and are not intended to be limiting.

What is claimed is:

1. An all-fiber inline optical tap, comprising:
a length of double-clad fiber comprising a first core, a first cladding, and a second cladding over the first cladding, the length of double-clad fiber configured to transport an optical signal in the first core with the optical signal bounded in a first interface between the first core and the first cladding, wherein the length of double-clad fiber further comprises a cladding-stripped portion with the second cladding stripped, wherein a part of the cladding-stripped portion comprises a coupling portion, and wherein a combined optical energy propagates in the length of double-clad fiber and is bounded in a second interface between the first cladding and the air around the cladding-stripped portion; and
one or more multimode fibers each respectively comprising a second core, a third cladding, outer claddings and buffer coatings over the third cladding, and a stripped portion with the outer claddings and buffer coatings stripped, wherein a part of the stripped portion comprises a taper portion with a predetermined taper slope with respect to an optical axis of each of the one or more multimode fibers, wherein a plurality of the taper portions embodied in the one or more multimode fibers are configured to be fused around the coupling portion with the third cladding directly coupled with the first cladding, and wherein each of the one or more multimode fibers is configured to respectively extract either a part of the combined optical energy or a part of the optical signal in the length of double-clad fiber,
wherein:
the part of the optical signal extracted comprises a leaking signal light escaped out from the first interface due to fiber bending or mismatch in a signal propagation pathway;
the part of the combined optical energy extracted comprises either an unabsorbed pump residual or other light scattering due to numerous imperfections in fiber components and splices utilized;
either the part of the combined optical energy or the part of the optical signal is configured to pass through the taper portion with a decreasing divergence angle against an optical axis of the taper portion for each internal reflection, thereby being extracted from the length of double-clad fiber with a reduced optical loss; and
the optical signal, after propagating through the coupling portion, continues to traverse in the first core and is bound in the first interface, thereby passing through the length of double-clad fiber with a reduced signal loss and a reduced beam quality degradation.

2. The all-fiber inline optical tap of claim 1, wherein the length of double-clad fiber comprises an input and an output, wherein a forward propagating direction is dictated as a direction from the input to the output whereas a backward propagating direction is dictated as a direction from the output to the input, wherein each of the one or more multimode fibers respectively comprises a downstream tap half close to the output of the length of double-clad fiber and an upstream tap half on an opposite side of the coupling portion, close to the input of the length of double-clad fiber, wherein the one or more multimode fibers comprise a plurality of downstream tap halves and a plurality of upstream tap halves, and wherein the plurality of the downstream tap halves and the plurality of the upstream tap halves are respectively configured to extract the part of either or both of the combined optical energy and the optical signal respectively in the forward propagating direction and in the backward propagating direction.

3. The all-fiber inline optical tap of claim 2, wherein both the part of the combined optical energy and the part of the optical signal in the forward propagating direction are configured to be extracted via the downstream tap half and comprise both an unabsorbed pump residual energy from an external laser source and the leaking signal light, and wherein a reflected part of the combined optical energy and a part of the optical signal in the backward propagating direction are configured to be extracted via the upstream tap half and comprise a reflected part of the optical signal trapped in the first cladding without launching into the first core, a back-reflection leaking signal light escaped out from the first interface due to fiber bending or mismatch, and a reflected stimulated Raman scattering (SRS) energy reflected from an external workpiece machined by the external fiber laser source.

4. The all-fiber inline optical tap of claim 3, wherein the length of double-clad fiber is configured to couple to an external cladding power stripper (CPS) in the external fiber laser source.

5. The all-fiber inline optical tap of claim 4, further comprising a power amplifier section coupled against the external CPS, wherein the power amplifier section comprises a section of double-clad fiber doped with a gain medium and a side-pump signal-and-pump combiner coupled in series with the section of double-clad fiber doped with the gain medium, wherein the side-pump signal-and-pump combiner is configured to provide either or both of a forward-pump and a backward-pump in a master-oscillator power-amplifier (MOPA) configuration, wherein the power amplifier section is configured to amplify a fiber laser light generated upstream, wherein an all-fiber inline optical tap is coupled between the external CPS and an output endcap, and wherein a part of either a forward-propagating laser light or a backward-propagating laser light reflected from the workpiece is respectively extracted from the downstream tap half and the upstream tap half for diagnostics and controls of a power gain in the power amplifier section.

6. The all-fiber inline optical tap of claim 3, further comprising a cladding power stripper (CPS) built on a fiber pigtail of the length of double-clad fiber as an integrated assembly configured to save additional splice, thereby reducing an optical loss and preserving laser beam quality.

7. The all-fiber inline optical tap of claim 3, wherein either the downstream tap half or the upstream tap half is configured to output an extracted light into an external optical filter to filter out an unwanted wavelength, thereby facilitating to extract either the part of the optical signal or the part of the combined optical energy for diagnostics and controls of the external fiber laser source.

8. The all-fiber inline optical tap of claim 6, wherein the integrated assembly with the CPS in either the downstream tap half or the upstream tap half is configured to output an extracted light into an external optical filter to filter out an unwanted wavelength, thereby facilitating to extract either the part of the optical signal or the part of the combined optical energy for diagnostics and controls of the external fiber laser source.

9. The all-fiber inline optical tap of claim 2, wherein the length of double-clad fiber of an all-fiber inline optical tap is configured to couple with an external low-reflectivity output coupler fiber-Bragg grating (OC FBG) in an external laser cavity, wherein either the downstream tap half or the upstream tap half in the all-fiber inline optical tap is used as an intra-cavity tap monitor and configured to extract a part of the optical signal in either or both of the forward propagating direction and the backward propagating direction for intra-cavity diagnostics and controls of the external fiber laser source.

10. The all-fiber inline optical tap of claim 8, wherein the part of the optical signal in either or both of the forward propagating direction and the backward propagating direction is configured to be extracted and outputted into either or both of a photo detector and an optical spectrum analyzer for diagnostics and controls of the external fiber laser source.

11. The all-fiber inline optical tap of claim 2, wherein both the downstream tap half and the upstream tap half have a sufficient light acceptance aperture such that either the part of the combined optical energy or the part of the optical signal extracted has a sampled power large enough to be used with a P-type semiconductor-Insulator-N-type semiconductor (PIN) diode.

12. The all-fiber inline optical tap of claim 1, wherein the plurality of the taper portions are configured to be further heated and stretched around the coupling portion, wherein each of the plurality of the taper portions is accordingly fused and embedded to an embedded depth in the coupling portion, and wherein the embedded depth and the predetermined taper slope are configured to be used to control a ratio between a sampled signal power and a fiber laser output power.

13. The all-fiber inline optical tap of claim 2, further comprising an all-fiber laser oscillator coupled against the all-fiber inline optical tap configured to extract either the part of the optical signal or the part of the combined optical energy in either or both of the forward propagating direction and the backward propagating direction for diagnostics and controls of the external fiber laser source, wherein at least one side-pump signal-and-pump combiner is coupled with a high-reflector fiber-Bragg grating (HR FBG) and configured to provide a forward-pump in a co-pump configuration.

14. The all-fiber inline optical tap of claim 2, further comprising an all-fiber laser oscillator configured to couple with an all-fiber inline optical tap in an upstream direction, wherein at least one side-pump signal-and-pump combiner is coupled with a low-reflectivity output coupler FBG (OC FBG) and configured to provide a backward-pump in a counter-pump configuration, and wherein the all-fiber inline optical tap is configured to extract either the part of the optical signal or the part of the combined optical energy in either or both of the forward propagating direction and the backward propagating direction for diagnostics and controls of the external fiber laser

15. The all-fiber inline optical tap of claim 2, further comprising an all-fiber laser oscillator, wherein a first side-pump signal-and-pump combiner and a second side-pump signal-and-pump combiner are respectively coupled with a high-reflector fiber-Bragg grating (HR FBG) and a low-reflectivity output coupler FBG (OC FBG), wherein the first side-pump signal-and-pump combiner and the second side-pump signal-and-pump combiner are respectively configured to provide a forward-pump and a backward-pump in a bidirectional-pump configuration, and wherein the all-fiber inline optical tap is configured to extract either the part of the optical signal or the part of the combined optical energy in either or both of the forward propagating direction and the backward propagating direction for diagnostics and controls of the external fiber laser.

16. The all-fiber inline optical tap of claim 2, wherein the one or more multimode fibers comprise at least one downstream tap half and at least one upstream tap half.

17. The all-fiber inline optical tap of claim 2, wherein the one or more multimode fibers comprise at least one downstream tap half with no upstream tap half.
